(19) United States
(12) Patent Application Publication
(10) Pub. No.: US 2020/0150627 A1
(43) Pub. Date: May 14, 2020

(54) Systems and Methods for Customized Food Items

(71) Applicant: Matthew Petrini, Norwalk, CT (US)

(72) Inventor: Matthew Petrini, Norwalk, CT (US)

(21) Appl. No.: 16/681,561

(22) Filed: Nov. 12, 2019

Related U.S. Application Data
(60) Provisional application No. 62/758,003, filed on Nov. 9, 2018.

(51) Int. Cl. G05B 19/4099; A23P 20/20; B33Y 10/00; B33Y 30/00; B33Y 50/02

(52) U.S. Cl. CPC G05B 19/4099; A23P 20/20; A23P 2020/253; B33Y 30/00; B33Y 50/02; B33Y 10/00

(57) ABSTRACT

Described herein is a food design system and method. A computing system hosting the application, including a database, and in communication with the user device, a cutting device, and a 3D printing device can receive a first request for a food item to be in the shape of the customized design. The computing system can transmit a first set of instructions to the cutting device or the 3D printing device to form a food preparation object to be in the shape of the customized design. The food preparation object can be configured to form and maintain a shape of the food item in the customized design.

### CROSS-REFERENCE TO RELATED APPLICATION

The present application claims priority benefit to a provisional patent application entitled “System and Method for Color Calibration,” which was filed on Nov. 9, 2018, and assigned Ser. No. 62/758,003. The entire content of the foregoing provisional patent application is incorporated herein by reference.

### BACKGROUND

The present disclosure is directed to systems and methods which allow users frequenting restaurants and food related facilities to customize their food items and more particularly to systems and methods for customizing food items using three dimensional printing and forming techniques.

### SUMMARY

Described herein is a food design system and method. In one embodiment, a first instance of an application executed on a user device including a first display, can receive input associated with generating a customized design. The first instance of the application can translate the input to generate the customized design. The first instance of the application can transmit a first request for a food item to be in a shape of the customized design to a computing system. The first request can include information associated with the food item and the customized design. The computing system hosting the application, including a database, and in communication with the user device, a cutting device, and a 3D printing device can receive the first request for the food item to be in the shape of the customized design. The computing system can transmit a first set of instructions to the cutting device or the 3D printing device to form a food preparation object to be in the shape of the customized design. The food preparation object can be configured to form and maintain a shape of the food item in the customized design.

A second instance of the application executed on the administrative device including a second display, and in communication with the computing system can render the first request for the food item in the shape of the customized design on the second display and verify a format of the customized design for the food item. The second instance of the application when executed on the administrative device can transmit the first request to the computing system in response to verifying the format of the customized design for the food item. The second instance of the application when executed on the administrative device can modify the customized design such that the customized design is in a compatible format.

A third instance of the application can be executed on a kitchen device including a third display, and in communication with the computing system. The computing system can be a second set of instructions to the kitchen device for preparing the food item. The third instance of the application when executed on the kitchen device can render a second set of instructions received from computing system on the third display.

The first instance of the application executed on the user device can receive uploaded digital media files to generate the customized design. The first instance of the application executed on the user device can transmit a second request to the computing system to retrieve a previously generated design.

The 3D printing device can receive the first set of instructions; and fabricate the food preparation object in the shape of the customized design. The cutting device can receive the first set of instructions and cut the food item or the food preparation object into the shape of the customized design.

In one embodiment, the food design system can include a cutting device, a 3D printing device, an administrative device, a kitchen device, and a user device executing a first instance of an application and including a first display. The first instance of the application when executed can be configured to receive input associated with generating a customized design, translate the input to generate the customized design, generate a file including the customized design, and transmit a first request for a food item to be in a shape of the customized design to a computing system. The first request can include the file of the customized design. A second instance of the application executed on the administrative device can be configured to render the first request for the food item in the shape of the customized design on the second display, verify a format of the customized design for the food item and transmit the first request to the computing system. The food design system can further include a computing system hosting the application, including a database, and in communication with the user device, the administrative device, the kitchen device, the cutting device, and the 3D printing device. The computing system can be configured to receive the first request for the food item to be in the shape of the customized design, extract the file including the customized design from the first request, transmit a first set of instructions to the cutting device or the 3D printing device to form a food preparation object to be in the shape of the customized design. The food preparation object is configured to form and maintain a shape of the food item in the customized design. The computing system is further configured to transmit a second set of instructions to the kitchen device to prepare the food item included in the first request.

The described systems and method provide for an application on a mobile computing device allowing a user to create a crust from a variety of pre-designed crust templates, from other users, from paid sponsorships and from a custom library, or to fully customize the shape of a crust/pie and the placement of toppings. A completed order will be sent to a point-of-sale (POS) device, a database and in parallel to an apparatus for mechanically automating the cutting of dough.

### BRIEF DESCRIPTION OF THE FIGURES

Illustrative embodiments are shown by way of example in the accompanying figures and should not be considered as a limitation of the present disclosure. The accompanying figures, which are incorporated in and constitute a part of this specification, illustrate one or more embodiments of the invention and, together with the description, help to explain the invention. In the figures:

FIG. 1 is a block diagram of an exemplary mobile device that can be utilized to implement and/or interact with embodiments of a food design system;

FIG. 2A illustrates an cutting device configured to design food items in accordance with an exemplary embodiment;

FIG. 2B illustrates a 3D printer configured to fabricate designs for food items in accordance with an exemplary embodiment;

FIG. 3 is a block diagram of a 3D printer in accordance with an exemplary embodiment;

FIG. 4 illustrates an exemplary food design system in accordance with an exemplary embodiment;

FIGS. 5-8 illustrate processes of the food design system in accordance with an exemplary embodiment;

FIG. 9 illustrates a block diagram an exemplary computing device in accordance with an exemplary embodiment; and

FIG. 10 is a flowchart illustrating the process of fabricating a design in the food design system.

### DETAILED DESCRIPTION

Described herein are food design systems and methods. In one embodiment, a first instance of an application executed on a user device including a first display, can receive input associated with generating a customized design. A user can interface with the user device to generate the design, upload digital medial files, and/or retrieve previously generated designs by the user or others using the first instance of the application. The first instance of the application can translate the input to generate the customized design. The first instance of the application can transmit a first request for a food item to be in a shape of the customized design to a computing system. The first request can include information associated with the food item and the customized design. The computing system hosting the application, including a database, and in communication with the user device, a cutting device, and a 3D printing device can receive the first request for the food item to be in the shape of the customized design. The computing system can transmit a first set of instructions to the cutting device or the 3D printing device to form a food preparation object to be in the shape of the customized design. The food preparation object can be configured to form and maintain a shape of the food item in the customized design.

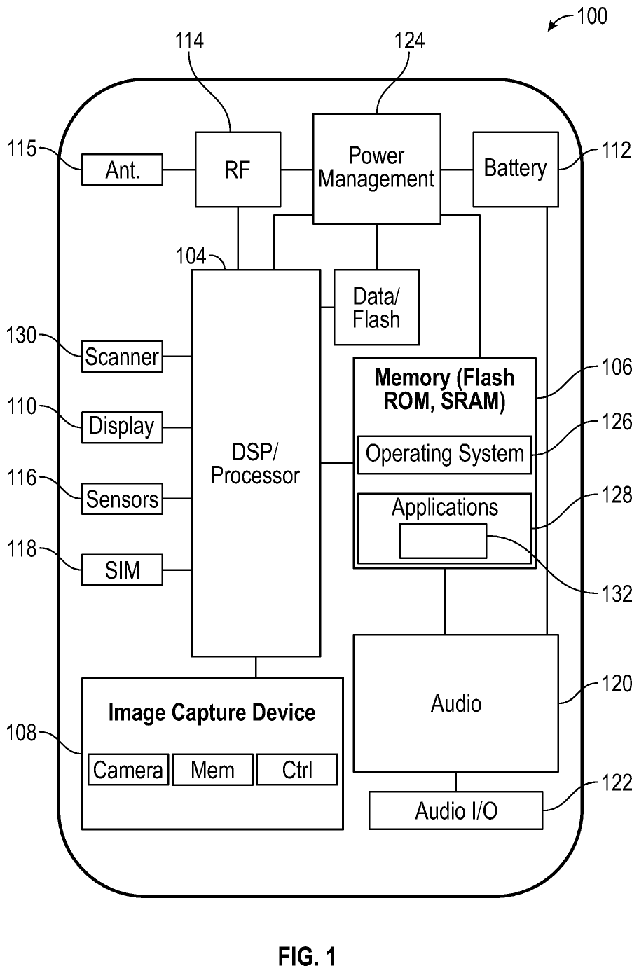

FIG. 1 is a block diagram of an exemplary mobile device that can be utilized to implement and/or interact with embodiments of a food design system. Device 100 can be a smartphone, tablet, subnotebook, laptop, personal digital assistant (PDA), handheld device, and/or any other suitable mobile device that can be programmed and/or configured to implement and/or interact with embodiments of the system via wireless communication. The user device 100 can include a processing device 104, such as a digital signal processor (DSP) or microprocessor, memory/storage 106 in the form a non-transitory computer-readable medium, an image capture device 108, a touch-sensitive display 110, a power source 112, a radio frequency transceiver 114 and a reader 130. Some embodiments of the user device 100 can also include other common components commonly, such as sensors 116, subscriber identity module (SIM) card 118, audio input/output components 120 and 122 (including e.g., one or more microphones and one or more speakers), and power management circuitry 124. The sensors 116 can include a location-based sensor 134, configured to determine the location of the user device 100.

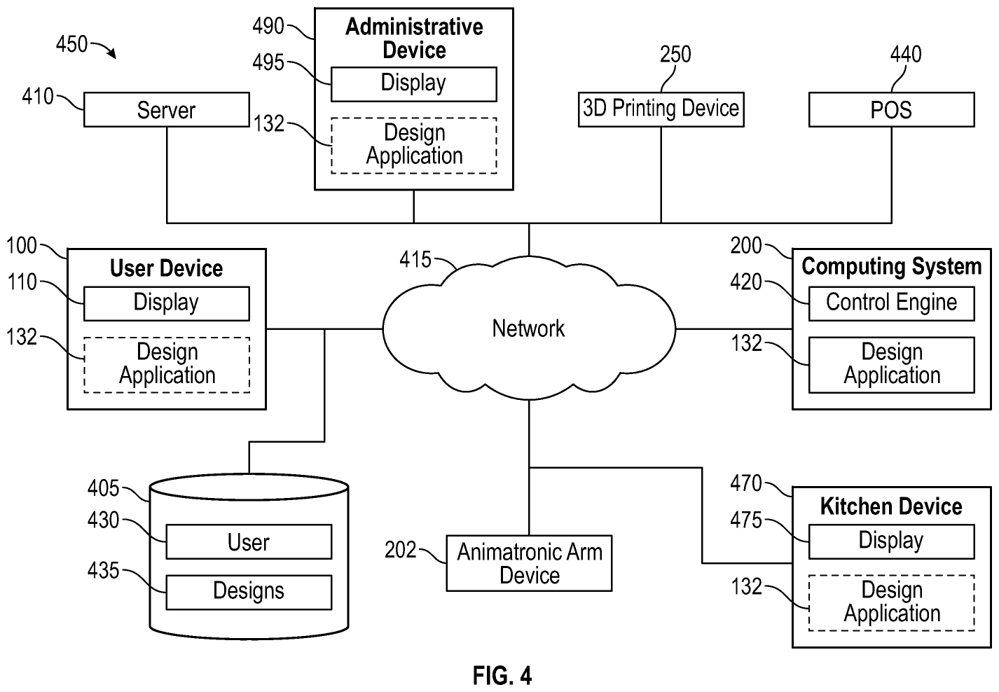

The memory 106 can include any suitable, non-transitory computer-readable storage medium, e.g., read-only memory (ROM), erasable programmable ROM (EPROM), electrically-erasable programmable ROM (EEPROM), flash memory, and the like. In exemplary embodiments, an operating system 126 and applications 128 can be embodied as computer-readable/executable program code stored on the non-transitory computer-readable memory 106 and implemented using any suitable, high or low level computing language and/or platform, such as, e.g., Java, C, C++, C #, assembly code, machine readable language, and the like. In some embodiments, the applications 128 can include an application 132 configured to interact with the microphone, a web browser application, a mobile application specifically coded to interface with one or more servers of embodiments of the system for data transfer in a distributed environment. A representative computing system and server are described in further detail with respect to FIG. 4. While memory is depicted as a single component those skilled in the art will recognize that the memory can be formed from multiple components and that separate non-volatile and volatile memory devices can be used.

The processing device 104 can include any suitable single- or multiple-core microprocessor of any suitable architecture that is capable of implementing and/or facilitating an operation of the user device 100. For example, a user can use the user device 100 in a facility to perform an image capture operation, capture a voice input of the user (e.g., via the microphone), transmit messages including a captured image and/or a voice input and receive messages from a central computing system, display data/information including GUIs of the user interface 110, captured images, voice input transcribed as text, and the like. The user device 100 can perform the aforementioned operations using on an internet browser executing on the mobile device, or any web-based application. The processing device 104 can be programmed and/or configured to execute the operating system 126 and applications 128 to implement one or more processes and/or perform one or more operations. The processing device 104 can retrieve information/data from and store information/data to the storage device 106.

The RF transceiver 114 can be configured to transmit and/or receive wireless transmissions via an antenna 115. For example, the RF transceiver 114 can be configured to transmit data/information, such as input based on user interaction with the user device 100. The RF transceiver 114 can be configured to transmit and/or receive data/information having at a specified frequency and/or according to a specified sequence and/or packet arrangement.

The touch-sensitive display 110 can render user interfaces, such as graphical user interfaces to a user and in some embodiments can provide a mechanism that allows the user to interact with the GUIs. For example, a user may interact with the user device 100 through touch-sensitive display 110, which may be implemented as a liquid crystal touch-screen (or haptic) display, a light emitting diode touch-screen display, and/or any other suitable display device, which may display one or more user interfaces (e.g., GUIs) that may be provided in accordance with exemplary embodiments.

The power source 112 can be implemented as a battery or capacitive elements configured to store an electric charge and power the user device 100. In exemplary embodiments, the power source 112 can be a rechargeable power source, such as a battery or one or more capacitive elements configured to be recharged via a connection to an external power supply. The scanner 130 can be implemented as an optical reader configured to scan and decode machine-readable elements disposed on objects.

In one embodiment, the mobile device can execute a design application 132. In response to executing the design application 132 a user can login into the design application 132. The login credentials can be transmitted to a computing system. Once the user is authenticated, the user can be presented a design interface on the display 110 to design food items. Alternatively, or in addition to, the user can be access previously design food items and a leaderboard of top designs by other users available to the public. In response to selecting to design a food item, a user can be presented pre-loaded templates or an option to design from scratch. The user can use input devices such as the multi-touch surface of the display 110, image capturing device 108, and/or sensors 116 to design the food item. Once designed the user can select to save the design for later use. The user can also select to make the design public or share the design with other selected users.

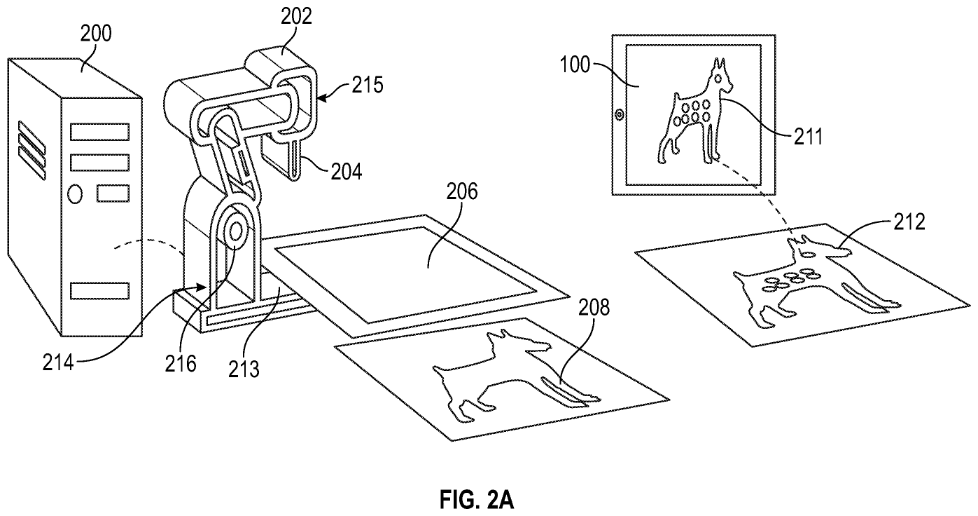

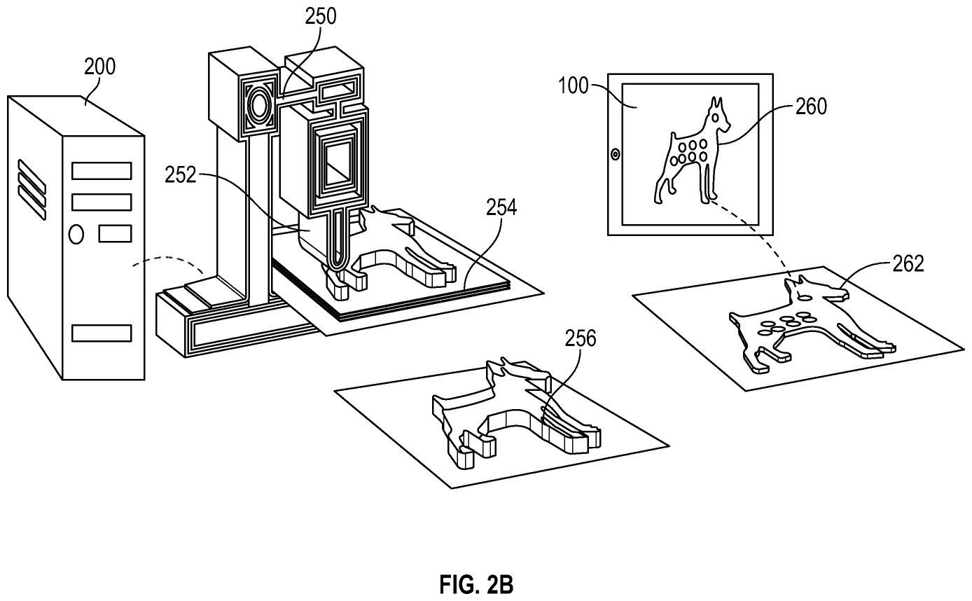

The user can select the design just created by the user, a previously created design by the user, or a design created by another user to be generated or fabricated. The selection can be transmitted to the computing system. In response to receiving the design, the computing system can generate or fabricate the design using a cutting device or a 3D printer. The computing system will be described in further detail with respect to FIGS. 2A-2B, and 4. The cutting device will be described in further detail with respect to FIGS. 2A and 4. The 3D printer will be described in further detail with respect to FIGS. 2B and 4.

FIG. 2A illustrates a cutting device 202 configured to design food items in accordance with an exemplary embodiment. In one embodiment, a computing system 200 can be in communication with the cutting device cutting device 202. The cutting device 202 can include a base 213, a body 214, a head 215, and a cutting mechanism 204. The base can be coupled to the body 214 and head 215 keeping the cutting device 202 upright. The cutting mechanism 204 can extend downward from the head 215. The cutting mechanism 204 can be a sharp edge blade or can be configured to emit a laser. The cutting device 202 can further include a motor 216. The motor 216 can be configured to move the upper half of the body 214, head 215 and cutting mechanism 204 in along three axes, e.g., the X, Y and Z axis.

In one embodiment, a design 211 can be received by the computing system 200 from a user device 100. The design 211 can be for a food item. A food preparation object 206 can be placed on the base 213 of the cutting device 202. The computing system can instruct the cutting device 202 to cut the food preparation object 206 into the shape of the received design 211. In response to receiving the instructions, the motor 216 of the cutting device 202 can control the movement of the upper half of the body 214, head 215, and cutting mechanism 204 to cut the food preparation object 206 into the received design. The food preparation object 206 can be transformed into the resultant food preparation object 208. The resultant food preparation object 208 can be used to prepare a food item 212. As a non-limiting example, the food preparation object 206 and resultant food preparation object 208 can be a sheet configured to hold pizza dough. The resultant food preparation object 208, can be used to prepare a pizza in the shape of the design, using the resultant food preparation object 208 (i.e., a sheet configured to hold pizza dough cut in the shape of the design).

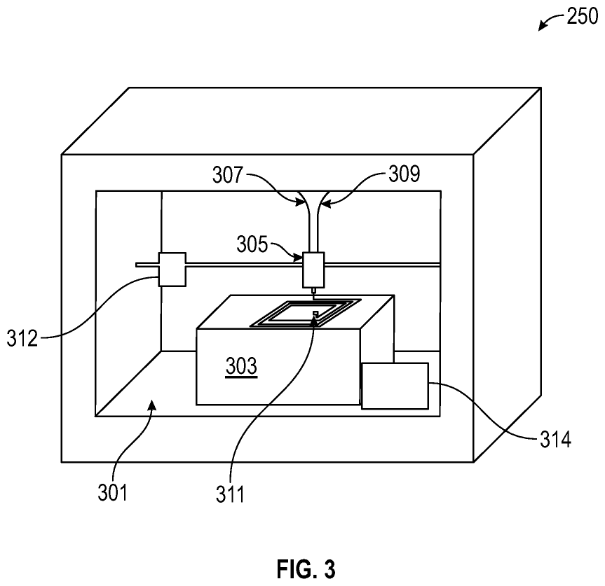

FIG. 2B illustrates a 3D printer 250 configured to fabricate designs for food items in accordance with an exemplary embodiment. In one embodiment, a computing system 200 can be in communication with a 3D printer 250. The 3D printer 250 can include an extruder 252 and a print bed. The print bed will be described in further detail with respect to FIG. 3.

In one embodiment, a design 211 can be received by the computing system 200 from a user device 100. The design 211 can be for a food item. The computing system can instruct the 3D printer 250 to fabricate a cookie cutter mechanism 254 with a shape of the received design 211. In response to receiving the instructions, the 3D printer 250 can fabricate the cookie cutter mechanism 254 on the print bed using the extruder 252. The use of the 3D printer 250 will be further described with respect to FIG. 3. The resultant cookie cutter mechanism 256 can be used to prepare a food item 262. As a non-limiting example, the resultant cookie cutter mechanism 256 can be a used to form the shapes of food items such as pizza into the design 211.

FIG. 3 shows an example 3D printer 250 for printing a three dimensional physical object 303 In this example embodiment, the 3D printer 250 includes an extruder 305 or 3D printer head that is configured to receive one or more spools or filaments of material (e.g., a first material 307 and a second material 309). The extruder 305 can selectively extrude the material to print the three dimensional product 303 on a print bed 301. The print bed 301 can be heated or unheated. The one or more materials fed into the extruder 305 can include the plastic or resin (and/or other materials) to fabricate the three-dimensional physical object 303. One or more motors 312 can control the motion of the extruder 305. A controller 314 and can be operatively coupled to the extruder 305, the one or more motors 312, and print bed 301. The controller 314 can control the operations of the one or more motors 312, the extruder 305, and the print bed 301.

The controller 314 can receive instructions to fabricate an instance of the three-dimensional physical object 303 based on a representation of the physical object as described herein. In some embodiments, the extruder can heat and melt the one or more materials before dispensing the material on the print bed 301 and/or can sinter the material as it is deposited on the print bed 301. In some embodiments, the extruder 305 can include a motor, a fan, a heat sink, a thermistor, a heating block, and a nozzle. The material can be dispensed through the nozzle after being heated by the heating block.

The controller 314 can control the one or more motors to control the motion of the extruder 305 to generate the structure of the instance of the three-dimensional physical object 303 on the print bed 301. The one or more motors 314 can move the extruder 305 along three axes, e.g., the X, Y and Z axis. Alternatively, the extruder 305 can be suspended using three arms, and the arms can move along the X, Y and Z axis at different rates.

As described above, the 3D printer 250 can receive instructions from a computing system (e.g., computing system 200 as shown in FIG. 2B) to fabricate a cookie cutter device to form food items into shapes of the cookie cutter device. The instructions can include a design of the cookie cutter device. In response to receiving instructions the extruder 305 can selectively extrude the material to print the cookie cutter device in the shape of the received design on the print bed 301.

FIG. 4 illustrates an exemplary food design system 450 in accordance with an exemplary embodiment. The food design system 450 can include one or more databases 405, one or more computing systems 400, one or more cutting devices 202, one or more 3D printers 250, one or more user devices 100, one or more POS terminals 440, one or more kitchen devices 470, and one or more administrative devices 490. The computing system 200 can be in communication with the databases 405, cutting devices 202, 3D printers 250, user devices 100, POS terminals 440, kitchen devices 470, and administrative devices 490, via a communications network 415. The computing system 200 can host a design application 132. The user device 100, kitchen device 470, and/or the administrative devices 490, can execute instances of the design application 132. The user device 100, kitchen device 470, and/or the administrative devices 490 can interface with the computing system 200 using the design application 132.

The computing system 200 may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs). Example embodiments may be implemented in digital electronic circuitry, or in computer hardware, firmware, software, or in combinations of them.

In an example embodiment, one or more portions of the communications network 415 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The server 410 includes one or more computers or processors configured to communicate with the computing system 200, the databases 405, cutting devices 202, 3D printers 250, user devices 100, POS terminals 440 and kitchen devices 470, via a communications network 615. The server 410 hosts one or more applications configured to interact with one or more components computing system 600 and/or facilitates access to the content of the databases 405. The databases 405 may store information/data, as described herein. For example, the databases 405 can include a users database 430 and a designs database 435. The users database 430 can store information associated with users of the user device 100, kitchen device 470, and/or design application 132. The databases 405 can be located at one or more geographically distributed locations from the computing system 200. Alternatively, the databases 405 can be located at the same geographically as the computing system 200.

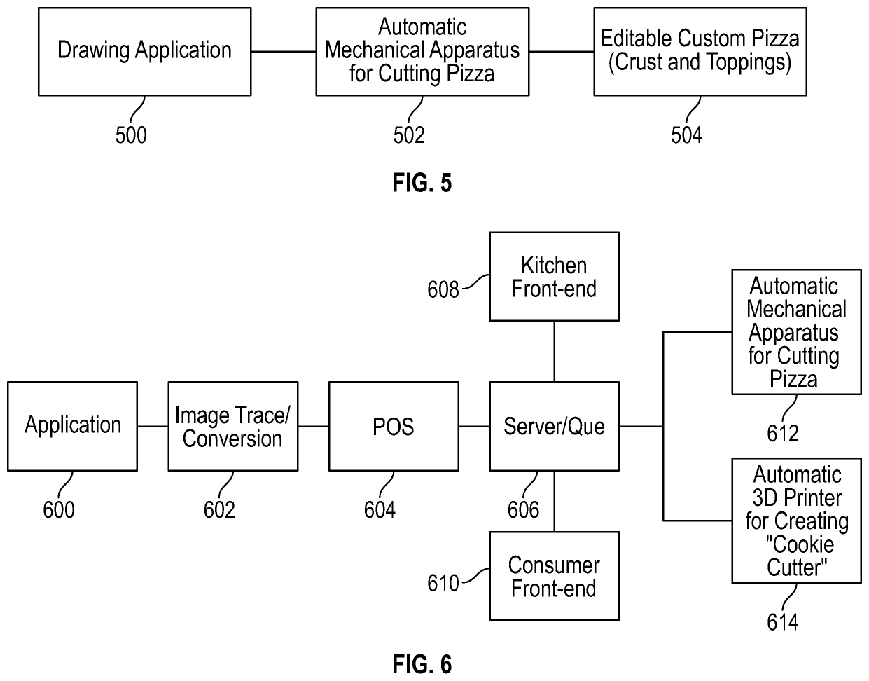

FIGS. 5-8 illustrate processes of the food design system in accordance with an exemplary embodiment. FIGS. 5-8 will be described concurrently with respect to food design system 450 as shown in FIG. 4. With reference to FIG. 5, a process 500 to interface with the design application is illustrated. In operation 502, a user can execute the design application 132 on the user device 100 to generate a customized design for a food item. The user can select designs from pre-designed templates for designs, designs generated by other uses, from paid sponsorships, from a custom design library, or a fully customized design. In operation 504, a designed object can be fabricated by the cutting device 202 and/or 3D printer 250 as described above with respect to FIGS. 2A and 2B respectively. For example, the cutting device 202 can autonomously cut the food item of a food preparation object into the shape of the customized design. Alternatively, or in addition to, the 3D printer 250 can fabricate a cookie cutter object. The cookie cutter object or food preparation object can be configured to hold a food item such as pizza dough, cut in the shape of the design. In operation 506, the object can be used to form the food item into the shape of the customized design. As a non-limiting example, the food item can be a pizza. The customized design can include a shape of the pizza crust and placement of toppings on the pizza crust.

With reference to FIG. 6, in operation 600, a user can execute the design application 132 on the user device 100. The design application 132 can render a user interface on the display 110 to generate a customized design for a food item. As described above, the user can select designs from pre-designed templates for designs, designs generated by other users, from paid sponsorships, from a custom design library, or a fully customized design. The customized design can be one or more of: images, GIFs, screenshots, icons, emojis, logos, animals, sports, shapes, cartoons, fruits, technology, people, places, transportation, clothing and adult content (body parts, beers/liquor, bachelor/bachelorette symbols). For example, the user device 100 can transmit a request to retrieve a pre-designed template for designs, designs generated from other user, or designs from custom design libraries to the computing system 200, via the design application 132. The computing system 200 can receive the request and retrieve the requested design from the design database 435 and transmit the design to the user device 100. The design application 132 executing on the user device 100 can render the received design on the display 110 of the user device 100. The user can modify the received design by interfacing with the user device 100. Alternatively, or in addition to, the user can generate the customized design on the user interface using an input device such as a keyboard, mouse, stylus, or multi-touch surface of the user device 100. In operation 602, the design application 132 can translate/trace design based on the input received from the user on the user device. In one embodiment, a user can upload pre-existing media files to assist in generating the customized design using the user device 100. For example, a user can upload an image file to generate the customized design. The design application 132 can format/convert any uploaded media files to make it compatible with the design application 132. Once the customized design is generated the design application 132 can output a file including the customized to be transmitted to the computing system. In operation 604, a user can place an order of the food item in the shape of the customized design by completing a transaction for the food item using a POS terminal 440. The user can submit their payment for the food item through the design application 132. The payment can be transmitted from the design application 132 to the computing system 200. The computing system 200 can transmit the payment to the POS terminal 440. The POS terminal 440 can be a virtual POS terminal 440.

In operation 606, in response to the user completing the transaction, the customized design to the computing system 200, via the design application 132. In operation 608, the computing system 200 can transmit the customized design to the kitchen device 470, via the design application 132. The kitchen device 470 can be operated by users preparing food items. In operation 610, the status of the order of the food item can be rendered on the display 110 on the user device 100. In operation 612, the computing system 200 can instruct the cutting device 202 to cut the food item or a food preparation object into the shape of the customized design. Alternatively, or in addition to, the computing system 200 can instruct the 3D printer 250 to fabricate a cookie cutter configured to form the food item into the shape of the customized design.

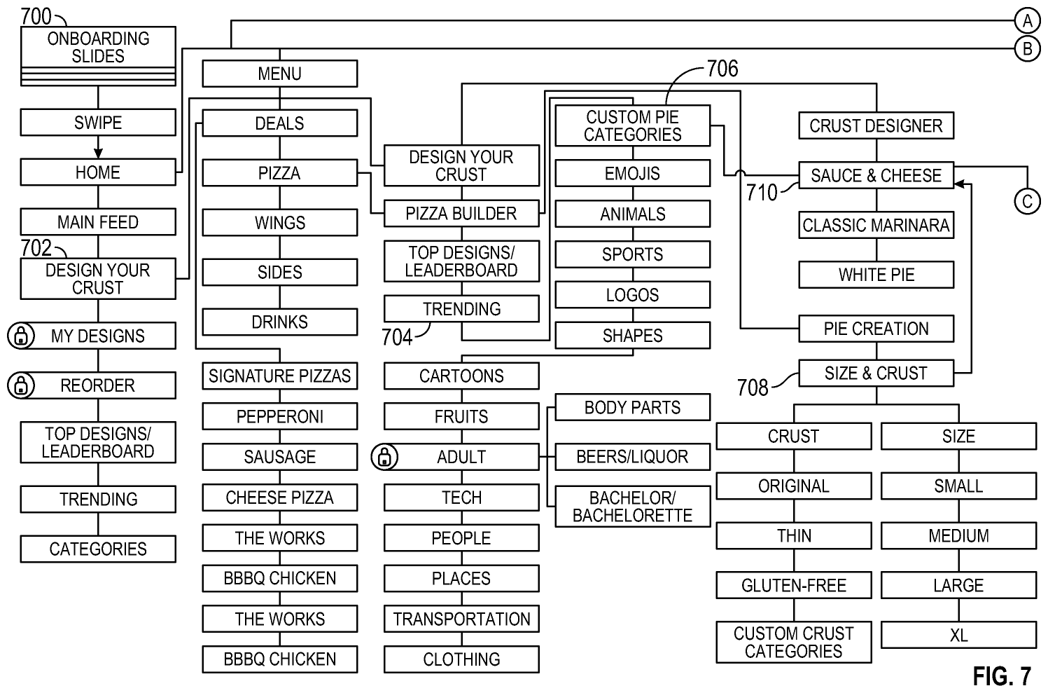

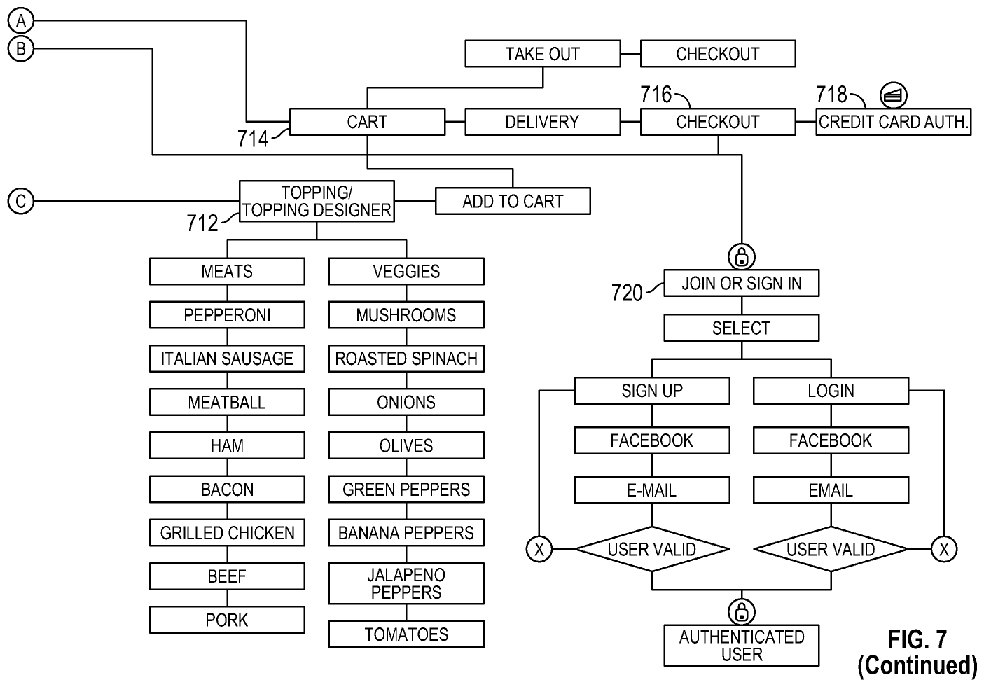

With reference to FIG. 7, in operation 700 a user can execute the design application 132 on the user device 100. The design application 132 can render a home screen on the display 110. In operation 720, the display application 132 can render a screen on the display 110 of the user device instructing the user to login or sign-up. In the event, the user already is has an account, the user can login using user credentials such as: user name/password, social media credentials (e.g., Facebook®, Twitter®, Snapchat®, or Instagram®), or an e-mail address. The design application 132 can transmit the user credentials to the computing system 200. The computing system 200 can query the users database 430 to verify the users credentials. In response to verifying the users credentials the computing system 200 can authenticate the user.

In the event, a user does not have an account with the design application 132, the user device 100 can render a screen on the display 100 to sign-up for an account with the design application 132. The user can provide social media credentials, or an e-mail, using the rendered screen. The design application 132 can transmit the credentials to the computing system 200. The computing system 200 can transmit the credentials to the users database 430 to create a new user account. In response to storing the credentials the computing system 200 can authenticate the user. Once the user is authenticated, the user can use the design application 132 to initiate an order for food items. For example, a menu of food items can be rendered on the display 110 in the design application 132. The menu can include deals, pizza, wings, sides, and drinks. The deals can include signature pizza, pepperoni, sausage, cheese pizza, the works, and BBQ chicken. Some of the food items can be eligible for customized design. For example, in response to selecting pizza from the menu the design application 132 can automatically render the design your crust screen. Alternatively, the user can jump straight to the design your curst screen from the main feed as will be described below.

In operation 702, in response to the computing system 200 authenticating the user, the design application can render a main feed screen presenting multiple selections on the display 110. The selections can include but are not limited to: design your crust, my designs, re-order, top designs, trending, and categories. In response to a user selecting my designs, the design application 132 can transmit a request to the computing system 200 to retrieve customized designs previously generated by user. The computing system 200 can retrieve customized designs previously generated by the user from the designs database 435. The customized designs previously generated by the user can be rendered on the display 110. A user can select a previously generated customized design.

In response to the user selecting the re-order selection, the design application 132 can transmit a request to retrieve previously ordered food items for the user to the computing system 200. The computing system 200 can query the user database 430 to retrieve previously ordered food items. The previously ordered food items can be rendered on the display 110.

In response to the user selecting top designs/leaderboard, trending, or categories selection, the design application 132 the design application 132 can transmit a request to retrieve the top designs/leaderboard, trending, or categories to the computing system 200. The computing system 200 can query the designs database 435 to retrieve top designs/leaderboard, trending, or categories. The top designs/leaderboard, trending, or categories can be rendered on the display 110.

In response to the user selecting the design your crust, the design application 132 can render a design your crust screen on the display 110. The design your crust screen can render selections to for the build your pizza and crust designer. In response to selecting the pizza builder selection, the design application 132 can render top designs/leaderboard designs, trending designs, or custom pie categories. The custom pie categories can include emoji designs, animal designs, sports designs, logo designs, shapes designs, cartoon designs, fruit designs, adult designs, tech designs, people designs, places designs, transportation designs, or clothing designs. The adult custom pie category can include body part designs, beers/liquor design, and bachelor/bachelorette party designs. The user can select one or more of the top designs/leaderboard designs, trending designs, or custom pie categories to generate their customized design for the food item such as a pizza crust. In response to the user selecting the curst designer selection a user can generate a fully customized design for a food item.

In operation 708, the design application 132 can render options for preparing the food item on the display 110. As described above, the food item can be a pizza. A user can select from the size and crust of the pizza. The selections for the type of crust can include one or more of: original, thin, gluten free and custom crust categories. The selections for the type of size can include, small, medium, large and XL. In operation 710, design application 132 can then render selections for the sauce and cheese of the pizza on the display 110. The selections for sauce and cheese can include classic marinara and white pizza. In operation 712, the design application 132 can render selections for the toppings/topping designer on the display 110. The selections for toppings/topping designer can include meats and veggies. The meats selection can include one or more of: pepperoni, Italian sausage, meatball, ham, bacon, grilled chicken, beef, and pork. The veggies selection can include on or more of: mushrooms, roasted spinach, onions, olives, green peppers, banana peppers, jalapeno peppers, and tomatoes. A user can specify the design they want the toppings to be laid out on the pizza. Once the user has made their selections for how to prepare the food items, the pizza can be added to the cart.

In operation 714 a user can place their order by completing the transaction for the food item to be shaped in the customized design. The user can select from takeout service or delivery service. In operation 716, a user can proceed with the checkout process. The design application 132 can render the login/sign-up screen for the user at checkout. In operation 718, once the user is authenticated, the user can make the payment for the food item. The payment can be transmitted to the computing system 200. The computing system 200 can forward the payment to the POS terminal 440.

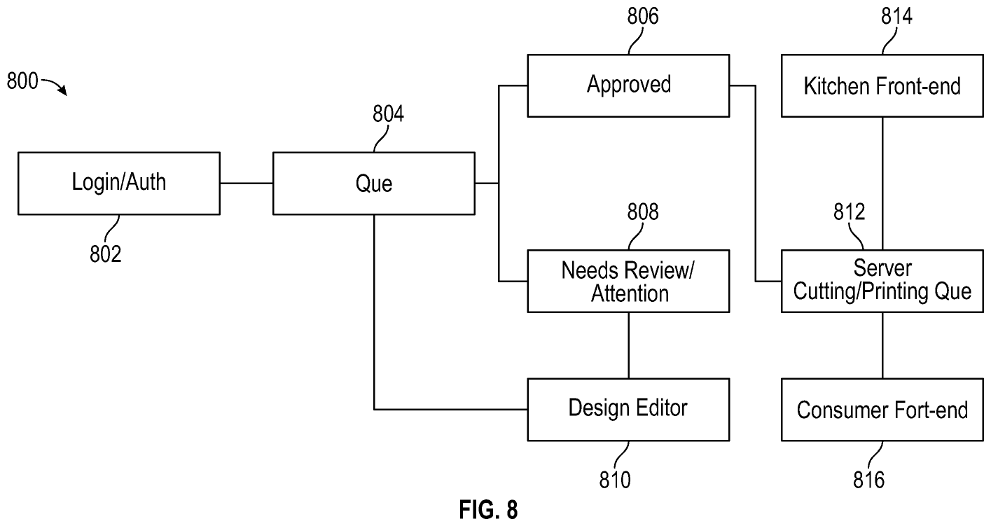

With reference to FIG. 8, a process 800 for receiving and processing the order for a food item and customized design. In operation 802, an administrative user can execute the design application 132 using an administrative device 490 and input their login credentials using the design application 132. The login credentials can be transmitted to the computing system using the design application 132. In operation 804, the administrative user can be presented a dashboard or queue of orders of food items in customized designs. In operation 806, the user can interface with the kitchen device 470 to approve the order and customized design. In one embodiment, the design application 132 can test the customized design to confirm the customized design is compatible with the cutting device 202, 3D printer 250 or the food item itself. Alternatively, in operation 808, the user can interface with the kitchen device 470 to send the order and customized design to other administrative staff for further review. For example, the design application 132 can determine the customized design is not compatible with the cutting device 202, 3D printer 250 or the food item and may need modifications. In operation 810, the other administrative staff can transmit the customized design which was received for further review to the design editor for modification to make it compatible with cutting device 202, 3D printer 250 or the food item. An administrative user can interface with the design application 132 to modify the customize design to make it compatible cutting device 202, 3D printer 250 or the food item. In one embodiment, the design application 132 of the administrative device 490 can transmit the modified design to the user device 100, via the computing system 200, to receive approval of the modification from the user requesting the food item in the modified design.

In response to the user preparing food item approving the customized design and/or user requesting the food item in the customized design approving the modifications to the customized design, the design application 132 of the administrative device 490 can transmit a request to the computing system 200 to generate the food item in the customized design. In operation 812, the computing system 200 can instruct the cutting device 200 and/or 3D printer 250 to generate a food preparation object or the food item itself in the customized design. In operation 814, the design application 132 can transmit the instructions to prepare the food item to the kitchen device 470. The design application 132 executing on the kitchen device 470 can render the instructions on the display 475 of the kitchen device 470. In operation 816, computing system 200 can transmit the status of the preparation of the food item to the user device 100. The design application 132 executed on the user device 100.

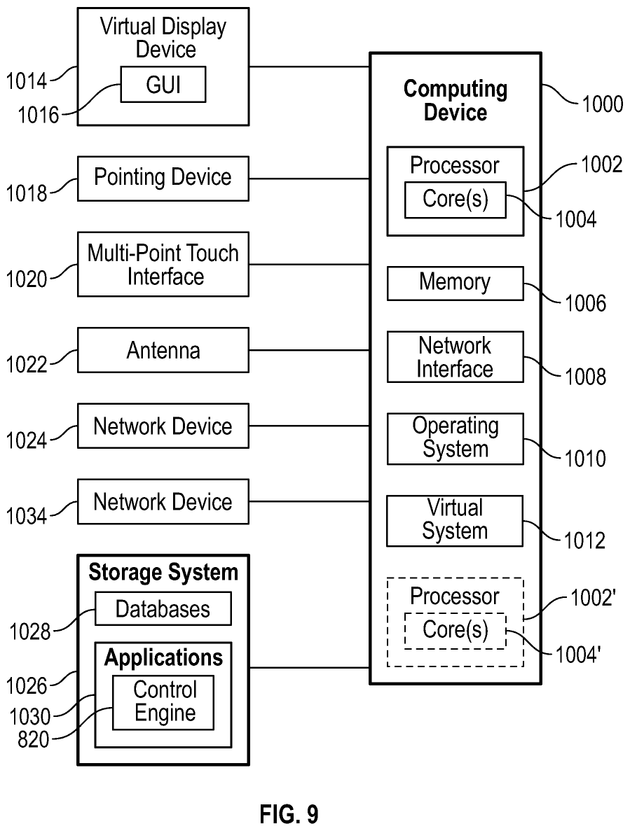

FIG. 9 is a block diagram of an example computing device for implementing exemplary embodiments of the present disclosure. Embodiments of the computing device 900 can implement embodiments of the food design system. The computing device can be embodied as a part of or in its entirety, the computing system 200, kitchen device 470, and the administrative device 490. The computing device 900 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 906 included in the computing device 900 may store computer-readable and computer-executable instructions or software (e.g., applications 930 such as the design application 132) for implementing exemplary operations of the computing device 900. The computing device 900 also includes configurable and/or programmable processor 902 and associated core(s) 904, and optionally, one or more additional configurable and/or programmable processor(s) 902′ and associated core(s) 904′ (for example, in the case of computer systems having multiple processors/cores), for executing computer-readable and computer-executable instructions or software stored in the memory 906 and other programs for implementing exemplary embodiments of the present disclosure. Processor 902 and processor(s) 902′ may each be a single core processor or multiple core (904 and 904′) processor. Either or both of processor 902 and processor(s) 902′ may be configured to execute one or more of the instructions described in connection with computing device 900.

Virtualization may be employed in the computing device 900 so that infrastructure and resources in the computing device 900 may be shared dynamically. A virtual machine 912 may be provided to handle a process running on multiple processors so that the process appears to be using only one computing resource rather than multiple computing resources. Multiple virtual machines may also be used with one processor.

Memory 906 may include a computer system memory or random access memory, such as DRAM, SRAM, EDO RAM, and the like. Memory 906 may include other types of memory as well, or combinations thereof. The computing device 900 can receive data from input/output devices such as, an image capturing device 934. The image capturing device 934 can capture still or moving images. A user may interact with the computing device 900 through a visual display device 914, such as a computer monitor, which may display one or more graphical user interfaces 916, multi touch interface 920 and a pointing device 918.

The computing device 900 may also include one or more storage devices 926, such as a hard-drive, CD-ROM, or other computer readable media, for storing data and computer-readable instructions and/or software that implement exemplary embodiments of the present disclosure (e.g., applications such as the design application 132). For example, exemplary storage device 926 can include one or more databases 928 for storing design files and information associated with users. The databases 928 may be updated manually or automatically at any suitable time to add, delete, and/or update one or more data items in the databases.

The computing device 900 can include a network interface 908 configured to interface via one or more network devices 924 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 922 to facilitate wireless communication (e.g., via the network interface) between the computing device 900 and a network and/or between the computing device 900 and other computing devices. The network interface 908 may include a built-in network adapter, network interface card, PCMCIA network card, card bus network adapter, wireless network adapter, USB network adapter, modem or any other device suitable for interfacing the computing device 900 to any type of network capable of communication and performing the operations described herein.

The computing device 900 may run any operating system 910, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 900 and performing the operations described herein. In exemplary embodiments, the operating system 910 may be run in native mode or emulated mode. In an exemplary embodiment, the operating system 910 may be run on one or more cloud machine instances.

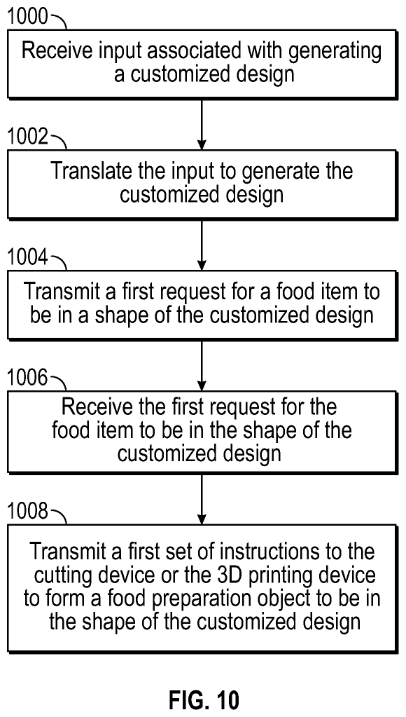

FIG. 10 is a flowchart illustrating the process of implementing the food design system. In operation 1000, a first instance of an application (e.g., design application 132 as shown in FIGS. 1 and 4) executed on a user device (e.g., user device 100 as shown in FIGS. 1 and 4) including a first display (e.g., display 110 as shown in FIGS. 1 and 4) can receive input associated with generating a customized design (e.g., customized design 211 as shown in FIGS. 2A-2B). In operation 1002, the first instance of the application executed on the user device 100 can translate the input to generate the customized design. In operation 1004, the first instance of the application executed on the user device can transmit a first request for a food item to be prepared in the shape of the customized design to the computing system (e.g., computing system 200 as shown in FIGS. 2A-2B and 4). The first request can include information associated with the food item and the customized design.

In operation 1006, the computing system computing system hosting the application and including a database, and in communication with the user device, a cutting device, and a 3D printing device, can receive the first request for the food item to be in the shape of the customized design. In operation 1008, the computing system can transmit a first set of instructions to the cutting device or the 3D printing device to form a food preparation object to be in the shape of the customized design. The food preparation object can be configured to form and maintain a shape of the food item in the customized design.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A food design system comprising:
a cutting device;
a 3D printing device; and
a user device executing a first instance of an application and including a first display, the first instance of the application when executed configured to:
receive input associated with generating a customized design;
translate the input to generate the customized design; and
transmit a first request for a food item to be in a shape of the customized design to a computing system, the first request including information associated with the food item and the customized design;
wherein the computing system hosting the application, including a database, and in communication with the user device, the cutting device, and the 3D printing device, is configured to:
receive the first request for the food item to be in the shape of the customized design;
transmit a first set of instructions to the cutting device or the 3D printing device to form a food preparation object to be in the shape of the customized design, wherein the food preparation object is configured to form and maintain a shape of the food item in the customized design.

2. The system of claim 1, further comprising an administrative device configured to execute a second instance of the application, including a second display, and in communication with the computing system, the second instance of the application when executed on the administrative device configured to:
render the first request for the food item in the shape of the customized design on the second display; and
verify a format of the customized design for the food item.

3. The system of claim 2, wherein the second instance of the application when executed on the administrative device configured to:
transmit the first request to the computing system in response to verifying the format of the customized design for the food item.

4. The system of claim 3, wherein the second instance of the application when executed on the administrative device configured to:
modify the customized design such that the customized design is in a compatible format.

5. The system of claim 1, further comprising a kitchen device configured to execute a third instance of the application, including a third display, and in communication with the computing system.

6. The system of claim 5, wherein the computing system is configured to transmit a second set of instructions to the kitchen device for preparing the food item.

7. The system of claim 6, the third instance of the application when executed on the kitchen device configured to:
render a second set of instructions received from computing system on the third display.

8. The system of claim 1, wherein the first instance of the application executed on the user device is configured to:
receive uploaded digital media files to generate the customized design.

9. The system of claim 1, wherein the first instance of the application executed on the user device is configured to:
transmit a second request to the computing system to retrieve a previously generated design.

10. The system of claim 1, wherein the 3D printer is configured to:
receive the first set of instructions; and
fabricate the food preparation object in the shape of the customized design.

11. The system of claim 1, wherein the cutting device is configured to:
receive the first set of instructions; and
cut the food item or the food preparation object into the shape of the customized design.

12. A food design method comprising:
receiving, via a first instance of an application executed on a user device including a first display, input associated with generating a customized design;
translating, via the first instance of the application, the input to generate the customized design;
transmitting, via the first instance of the application, a first request for a food item to be in a shape of the customized design to a computing system, the first request including information associated with the food item and the customized design;
receiving, via the computing system hosting the application, including a database, and in communication with the user device, a cutting device, and a 3D printing device, the first request for the food item to be in the shape of the customized design; and
transmitting, via the computing system, a first set of instructions to the cutting device or the 3D printing device to form a food preparation object to be in the shape of the customized design, wherein the food preparation object is configured to form and maintain a shape of the food item in the customized design.

13. The method of claim 12, further comprising rendering, via an a second instance of the application executed on the administrative device including a second display, and in communication with the computing system, the first request for the food item in the shape of the customized design on the second display; and
verifying, via the second instance of the application, a format of the customized design for the food item.

14. The method of claim 13, further comprising:
transmitting, via the second instance of the application when executed on the administrative device, the first request to the computing system in response to verifying the format of the customized design for the food item.

15. The method of claim 14, further comprising:
modifying, via the second instance of the application when executed on the administrative device, the customized design such that the customized design is in a compatible format.

16. The method of claim 12, wherein a third instance of the application is executed on a kitchen device including a third display, and in communication with the computing system.

17. The method of claim 16, further comprising transmitting, via the computing system, a second set of instructions to the kitchen device for preparing the food item.

18. The method of claim 17, further comprising:
rendering, via the third instance of the application when executed on the kitchen device, a second set of instructions received from computing system on the third display.

19. The method of claim 12, further comprising:
receiving, via the first instance of the application executed on the user device, uploaded digital media files to generate the customized design.

20. The method of claim 12, further comprising:
transmitting, via the first instance of the application executed on the user device, a second request to the computing system to retrieve a previously generated design.

21. The method of claim 12, further comprising:
receiving, via the 3D printing device the first set of instructions; and
fabricating, via the 3D printing device, the food preparation object in the shape of the customized design.

22. The method of claim 12, wherein the cutting device is configured to:
receiving, via the cutting device, the first set of instructions; and
cutting, via the cutting device, the food item or the food preparation object into the shape of the customized design.

23. A food design system comprising:
a cutting device;
a 3D printing device;
an administrative device;
a kitchen device;
a user device executing a first instance of an application and including a first display, the first instance of the application when executed configured to:
receive input associated with generating a customized design;
translate the input to generate the customized design;
generate a file including the customized design;
transmit a first request for a food item to be in a shape of the customized design to a computing system, the first request including the file of the customized design;
wherein a second instance of the application executed on the administrative device is configured to:
render the first request for the food item in the shape of the customized design on the second display;
verify a format of the customized design for the food item; and
transmit the first request to the computing system;
wherein the computing system hosting the application, including a database, and in communication with the user device, the administrative device, the kitchen device, the cutting device, and the 3D printing device, is configured to:
receive the first request for the food item to be in the shape of the customized design;
extract the file including the customized design from the first request;
transmit a first set of instructions to the cutting device or the 3D printing device to form a food preparation object to be in the shape of the customized design, wherein the food preparation object is configured to form and maintain a shape of the food item in the customized design; and
transmit a second set of instructions to the kitchen device to prepare the food item included in the first request.
